(19) United States
(12) Patent Application Publication
(10) Pub. No.: US 2012/0215447 A1
(43) Pub. Date: Aug. 23, 2012

(54) METHOD FOR DETERMINING PALEO-PORE PRESSURE

(75) Inventor: Fang Lin, Sugar Land, TX (US)

(73) Assignee: Chevron U.S.A. Inc.

(21) Appl. No.: 13/032,272

(22) Filed: Feb. 22, 2011

(51) Int. Cl. G01V 8/02; G06F 19/00

(52) U.S. Cl. 702/6

(57) ABSTRACT

In some aspects of the disclosure, a computer-implemented method performed by one or more processors and configured to determine a pressure of a sample multi-component gas inclusion in a sub-surface formation is disclosed. The computer-implemented method includes determining a set of Raman signatures for a calibration multi-component synthetic gas mixture at a plurality of temperatures, at a plurality of pressures and at a plurality of gas concentration mixing ratios to produce a model of pressure and Raman signatures; determining a second Raman signature of the sample multi-component gas mixture in the inclusion from the sub-surface formation; and determining a pressure of the second multi-component gas mixture based on the determined second Raman signature and the model of pressure and the first set of Raman signatures.

### FIELD

The present invention relates generally to spectroscopic techniques to characterize geologic material and more particularly to Raman spectroscopic characterization.

### BACKGROUND

Methane (CH₄) has received attention from researches in diverse fields because it is a major component of natural gas, represents a major contributor to global warming and has been detected in the atmosphere or at the surface of extraterrestrial bodies. Interest in the properties of methane has also been stimulated by the discovery of large deposits of methane hydrate, also called methane clathrate, a compound in which methane molecules resides in cages formed by water molecules, owing to the potential of methane as a future energy resource and as a potential hazard by sea.

Raman spectroscopy is a vibrational spectroscopic technique that monitors differences between the frequency of the incident laser and that of the stimulated Raman scattering from the investigated material. The Raman peak position, peak width and peak intensity reflect the microenvironment of the investigated molecules in terms of the atoms involved in bonding, the bond length, bond strength and polarizability. The two Raman active vibrational modes for CH₄ are the symmetric stretching mode and the twisting mode, usually denoted as ν₁ and ν₂, respectively. Two weaker methane bands are the asymmetric C-H stretching and the overtone of the asymmetric C-H bending, usually denoted as ν₃ and 2ν₂, respectively. Typically, the methane ν₃ band intensity is lowered relative to the methane 2ν₂ as the pressure is raised.

### SUMMARY

In accordance with some aspects of the disclosure, a computer-implemented method performed by one or more processors and configured to determine a pressure of a sample multi-component gas inclusion in a sub-surface formation is disclosed. The computer-implemented method can include determining a first set of Raman signatures for a calibration multi-component synthetic gas mixture at a plurality of temperatures, at a plurality of pressures and at a plurality of gas concentration mixing ratios to produce a model of pressure and Raman signatures; determining a second Raman signature of the sample multi-component gas mixture in the inclusion from the sub-surface formation; and determining a pressure of the sample multi-component gas mixture based on the determined second Raman signature and the model of pressure and the first set of Raman signatures.

The calibration multi-component synthetic gas mixture, the sample multi-component gas mixture, or both include, for example, methane and one or more of additional gas species. The additional gas species can include, for example, ethane, propane, butane, carbon dioxide, or hydrogen sulfide.

The method can include acquiring Raman data by establishing a calibration data set for determination of relationships among Raman signal, gas pressure and gas compositions at a plurality of temperatures and at a plurality of pressures.

The method can include establishing a pressure-volume-temperature (PVT) model for the second multi-component gas mixture.

The Raman signatures can include, for example, a peak position, a peak area, a peak height and a peak width at half height. The peak position can include, for example, a Raman methane symmetric stretching band (ν₁), a methane asymmetric stretching band (ν₃), an overtone of methane asymmetric bending (2ν₂), an ethane symmetric stretching band (ν₁) or a propane symmetric stretching band (ν₁).

The composition of the second multi-component gas mixture in the inclusion can be determined at or about room temperature.

The method can include determining an internal pressure of the second multi-component gas mixture in the inclusion at reservoir temperature based on the PVT model and a pressure of the second multi-component gas mixture at or about room temperature.

The method can include determining a pressure history of the inclusion based on a temperature history of the reservoir, the pressure and the temperature at or about room temperature and the PVT model.

In accordance with aspects of the present disclosure, a computer-implemented method including one or more processors arranged to determine a pressure of a multi-component gas inclusion in a sub-surface formation is disclosed. The computer-implemented method can include determining a composition of a multi-component gas mixture in an inclusion from a sub-surface formation; and determining an internal pressure of the multi-component gas mixture based on an established gas pressure-gas Raman signature relationship for a multi-component synthetic gas mixture.

In accordance with aspects of the present disclosure, an article of manufacture for determining pressure of a multi-component gas inclusion in a sub-surface formation including a computer usable medium having a computer readable program code embodied therein is disclosed. The computer readable program code adapted to be executed by a processor to implement functions including determining a composition of a multi-component gas mixture in an inclusion from a sub-surface formation; and determining an internal pressure of the multi-component gas mixture based on an established gas pressure-gas Raman signature relationship for a multi-component synthetic gas mixture.

In accordance with aspects of the present disclosure, a computer-implemented method operable by one or more processors arranged to determine a pressure of a multi-component gas inclusion in a sub-surface formation is disclosed. The method can include acquiring Raman data for a first multi-component synthetic gas mixture; establishing a gas pressure-gas Raman signal relationship for the first multi-component synthetic gas mixture; determining a composition of a second multi-component gas mixture in an inclusion from a sub-surface formation; and determining an internal pressure of the second multi-component gas mixture based on the established gas pressure-gas Raman signal relationship for the first multi-component synthetic gas mixture.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is an example of a Raman spectroscopy system.

FIG. 2 is a Jablonski energy level diagram schematically representing Rayleigh and Raman scattering processes for a hypothetical analyte.

FIG. 3 is an example process flow for determining properties of subsurface gas inclusions in accordance with aspects of the present disclosure.

FIG. 4 is an example schematic pressure (P)—temperature (T) phase diagram in accordance with aspects of the present disclosure.

### DETAILED DESCRIPTION

Raman spectroscopy is a technique for analyzing molecules or materials. In conventional Raman Spectroscopy, an analyte (or sample) that is to be analyzed is irradiated with high intensity monochromatic electromagnetic radiation provided by a radiation source, such as a laser. An electromagnetic radiation detector detects radiation that is scattered by the analyte. The characteristics of the scattered radiation provide information relating to the analyte. The term “analyte” as used herein means any molecule, molecules, material, substance, or matter that is to be analyzed or detected by Raman spectroscopy.

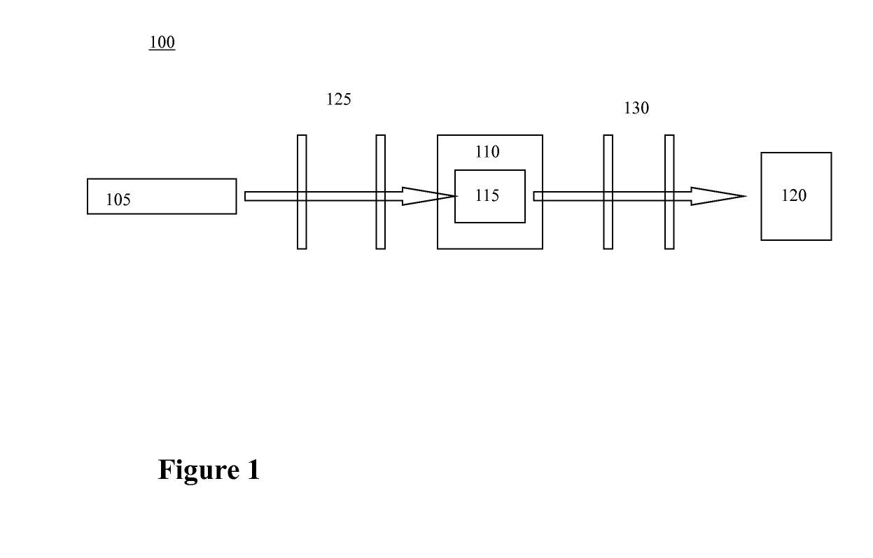

FIG. 1 shows a Raman spectroscopy system generally at 100. Electromagnetic radiation source 105 is configured to emit incident electromagnetic radiation. Radiation source 105, for example, can be a commercially available laser. The wavelength or wavelengths of incident electromagnetic radiation that may be emitted by electromagnetic radiation source 105 typically can be within or near the visible region of the electromagnetic radiation spectrum.

Analyte stage 110 on which an analyte 115 can be positioned to receive the incident electromagnetic radiation from electromagnetic radiation source 105. Analyte stage 110 can be an optical cell that can house analyte 115 at a variety of temperatures and pressures. Electromagnetic radiation detector 120 can be configured to detect at least a portion of scattered radiation that is scattered by analyte 115. One or more additional optical components 125 can be positioned between radiation source 105 and analyte stage 110 and/or one or more optical components 130 can be positioned between analyte stage 110 and radiation detector 120. Such optical components may include lenses, filters, and apertures. Optical components 125 positioned between radiation source 105 and analyte stage 110 can be used to collimate, filter, or focus the incident radiation before the incident radiation impinges on analyte stage 110. Optical components 130 positioned between analyte stage 110 and radiation detector 120 can be used to collimate, filter, or focus the scattered radiation. Additionally or alternatively, a radiation filter, such as a notch filter, may be positioned between the analyte stage and the detector to prevent Rayleigh scattered radiation from being detected by the detector, thus allowing only the Raman scattered radiation to be received by the detector.

Radiation detector 120 can be configured to receive and detect at least a portion of the scattered radiation that is scattered by analyte 115 disposed on analyte stage 110. Radiation detector 120 may include a device for determining the wavelength of the scattered radiation (for example, a monochromator) and a device for determining the intensity of the scattered radiation (for example, a photomultiplier). Typically, the scattered radiation is scattered in all directions relative to analyte stage 110. The radiation detector 120 can detect the Raman signal and the wavelengths and corresponding intensity of the Raman scattered radiation may be determined and used to provide a Raman spectral graph. Analytes generate unique Raman spectral graphs that can be used to obtain information relating to the analyte including, but not limited to, the identification of an unknown analyte, or the determination of physical and chemical characteristics of a known analyte.

As the incident radiation impinges on analyte 115, at least some of the incident radiation will be scattered by analyte 115. A majority of the photons of the incident radiation that impinge on analyte 115 are elastically scattered by analyte 115. In other words, the scattered photons have the same energy, and thus the same wavelength, as the incident photons. This elastic scattering of photons is termed “Rayleigh scattering,” and radiation consisting of these elastically scattered photons is termed “Rayleigh scattered radiation” or “Rayleigh radiation.”

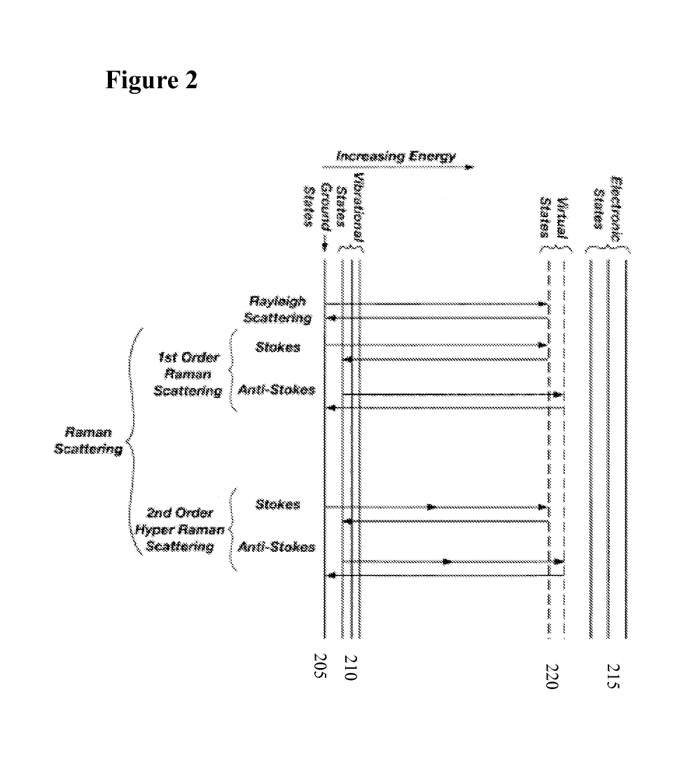

The Rayleigh scattering process can be further described with reference to the simplified Jablonski diagram shown schematically in FIG. 2, which illustrates various energy levels of a hypothetical analyte. In FIG. 2, energy levels of the analyte are represented as horizontal lines. As seen therein, the ground state energy level (the lowest energy level) 205 is shown at the bottom of the diagram, excited vibrational energy states 210 are shown just above the ground state, excited electronic energy states 215 are shown at the top of the diagram, and virtual excited states 220 are shown between the excited electronic states and the excited vibrational states. As seen in FIG. 2, Rayleigh scattering typically involves absorption of a single photon of the incident radiation by the analyte, which causes the analyte to transition from the ground state to a virtual state followed by relaxation to the ground state. As the analyte relaxes to the ground state, the analyte emits a photon of scattered radiation that has energy equal to that of the photon of the incident radiation. In this manner, the photon of the incident radiation is considered to have been elastically scattered.

In addition to the Rayleigh scattering of photons, a very small fraction of the photons of the incident radiation may be inelastically scattered by the analyte. Raman scattered radiation is also emitted from the analyte. Typically, only about 1 in 10⁷ of the photons of the incident radiation is inelastically scattered by the analyte. These inelastically scattered photons have a different wavelength than the photons of the incident radiation. This inelastic scattering of photons is termed “Raman scattering,” and radiation consisting of Raman scattered photons is termed “Raman scattered radiation” or “Raman radiation.” The photons of the Raman scattered radiation can have wavelengths less than, or more typically, greater than the wavelength of the photons of the incident radiation.

The Raman scattering process can be further described with reference to the simplified Jablonski diagram shown in FIG. 2. When a photon of the incident radiation collides with the analyte, energy can be transferred from the photon to the analyte or from the analyte to the photon. When energy is transferred form the photon of the incident radiation to the analyte, the Raman scattered photon will have a lower energy and a corresponding longer wavelength than the incident photon. These Raman scattered photons having lower energy than the incident photons are collectively referred to in Raman spectroscopy as the “Stokes radiation.” As seen in FIG. 2, 1st order Stokes Raman scattering typically involves absorption of a single photon of the incident radiation by the analyte, which causes the analyte to transition from a first energy state (for example, the ground state) to an excited virtual state. The analyte then relaxes to an excited vibrational state of higher energy than the first energy state. As the analyte relaxes to the excited vibrational state, the analyte emits a photon of scattered radiation that has less energy (and a longer wavelength) than the photon of the incident radiation. In this manner, the photon of the incident radiation is considered to have been inelastically scattered.

When energy is transferred from the analyte to a Raman scattered photon, the Raman scattered photon will have a higher energy and a corresponding shorter wavelength than the photon of the incident radiation. These Raman scattered photons, which have higher energy than the incident photons, are collectively referred to in Raman spectroscopy as the “anti-Stokes radiation.” As seen in FIG. 2, 1st order anti-Stokes Raman scattering typically involves absorption of a single photon of the incident radiation by the analyte, which causes the analyte to transition from an excited vibrational energy state to an excited virtual state. The analyte then relaxes to a lower energy state (for example, the ground state) than the excited vibrational energy state. As the analyte relaxes to the lower energy state, the analyte emits a photon of scattered radiation that has more energy (and a shorter wavelength) than the photon of the incident radiation. In this manner, the photon of the incident radiation is considered to have been inelastically scattered. The shift in energy (wavelength, frequency, or wave number) of the Raman scattered photons in relation to the Rayleigh scattered photons is known as the “Raman shift.”

Raman scattering primarily involves a one photon excitation—one photon relaxation process. These Raman scattering processes are often referred to as “1st order” Raman scattering processes. However, multiple photon excitation—single photon relaxation processes are also observed and are referred to as “hyper Raman scattering” processes. Two photon excitation—one photon relaxation scattering processes are referred to as “2nd order” hyper Raman scattering processes, three-photon excitation—one photon relaxation processes are referred to as “3rd order” Raman scattering processes, etc. These higher order Raman scattering processes are often referred to as “harmonics.”

In 2nd order scattering processes, a molecule of the analyte in an initial energy state absorbs the energy from two photons of the incident radiation causing an energy transition in the analyte to a virtual excited state, followed by relaxation to a final energy state and emission of a single scattered photon. If the final energy state is the same as the initial energy state, the scattering process is referred to as hyper Raleigh scattering. If the final energy state is higher than the initial energy state, the scattering process is referred to as 2nd order Stokes hyper Raman scattering. Finally, if the final energy state is lower than the initial energy state, the scattering process is referred to as 2nd order anti-Stokes hyper Raman scattering. The Stokes and anti-Stokes 2nd order hyper Raman scattering processes are also represented in the Jablonski diagram shown in FIG. 2.

Information may be obtained from hyper Raman scattered radiation that cannot be obtained from 1st order Raman scattered radiation. In particular, vibrational information may be suppressed in Raman scattered radiation due to symmetry issues, thereby resulting in what are often referred to as “silent modes.” These silent modes may not be suppressed in the hyper Raman scattered radiation.

When an analyte is irradiated with incident radiation, the scattered radiation may include Raman scattered radiation, which may comprise 1st order Raman scattered radiation (Stokes and anti-Stokes) and higher order hyper Raman scattered radiation (Stokes and anti-Stokes), in addition to Rayleigh scattered radiation. The Raman scattered radiation that is scattered by the analyte (including the hyper Raman scattered radiation) is often referred to as the “Raman signal.”

Using the system described above, various Raman signatures for a particular synthetic analyte can be measured and used to characterize properties of inclusions found in sub-surface formations. The position of a Raman band reflects the frequency of a specific vibration mode of a molecule. The Raman spectrum uniquely identifies a molecular species, making this technique useful in the qualitative analysis of complex mixtures. However, the exact vibration frequency (peak position) changes as a function of the molecular environment. For example, CH₄ gas symmetric stretching band tends to shift to lower relative wavenumber as density increases. For example, the peak position systematically shifts to lower wavenumber as pressure increases.

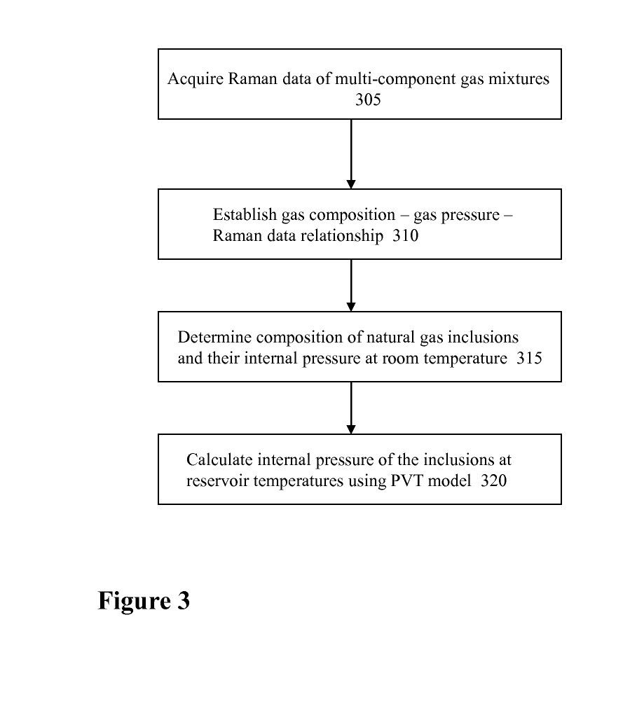

FIG. 3 is an example process flow for determining properties of subsurface gas inclusions in accordance with aspects of the present disclosure. Generally, the process involves determining relationships among Raman signal, gas pressure and gas composition for synthetic multi-component gas mixture at a plurality of pressures and at a plurality of temperatures and using this relationship to determine properties of gases within rock inclusions. At 305, Raman data is acquired in multi-component synthetic gas mixtures. Raman data can include Raman signatures including, for example, a peak position, a peak area, a peak height, a peak width at half height. The peak position can include, for example, position of a Raman methane symmetric stretching band (ν₁), a methane asymmetric stretching band (ν₃), an overtone of methane asymmetric bending (2ν₂), an ethane symmetric stretching band (ν₁) or a propane symmetric stretching band (ν₁). A calibration data set can then be established for determination of relationships among Raman signal, gas pressure and gas composition at room temperature.

At 310, gas pressure-gas Raman signal relationship is established in a multi-component synthetic gas system. The multi-component synthetic gas mixture can include, for example, methane and one or more of additional gas species. The additional gas species can include, for example, ethane, propane, butane, carbon dioxide, or hydrogen sulfide. Data obtained can be processed and analyzed to extract the intrinsic relationship between gas Raman signal and gas pressure for each composition tested. Statistical regression can be run on the raw data to generate mathematical equations that can be used to calculate gas pressure, if gas Raman data are obtained and gas composition is known. These equations can be used to determine the pressure inside natural gas inclusions. The pressure calculated by the equations will be gas pressure at room temperature, because all data used in multi-variable regression were collected at room temperature.

For example, to establish the relationship for methane-ethane system, methane and ethane gas are mixed in an optical gas chamber with different ratios. Gas pressure inside the optical chamber will be monitored through a pressure gauge. Relative fraction of each gas component in the mixed gas can be calculated using pressure data measured before gas mixing and after gas mixing. Then, Raman data can be measured under pressure in the gas chamber. This is then repeated under different pressure conditions and for different gas mixing ratios. A statistical regression can be run on the pressure and composition data collected to generate one or more mathematical equations showing the relationship between pressure and methane Raman shift. In general, these equations can be expressed as a gas pressure changing as a function of the gas composition, gas temperature and gas Raman shift.

At 315, compositions of natural gas inclusions are determined at their internal pressure at room temperature. Relationships derived in 305 and 310 are used to characterize properties of natural gas inclusions from oil or gas fields. After chemical composition of the gas inside a natural inclusion is determined, and Raman signal of the gas is collected, internal pressure of the inclusion can be calculated using the equations from 310. This pressure is the internal pressure of the gas inclusion at room temperature, which is often lower than the pressure inside the inclusions at reservoir temperature. This is because when a rock containing an inclusion is lifted from subsurface to surface, internal pressure of an inclusion residing in the rock will drop due to the decrease of temperature.

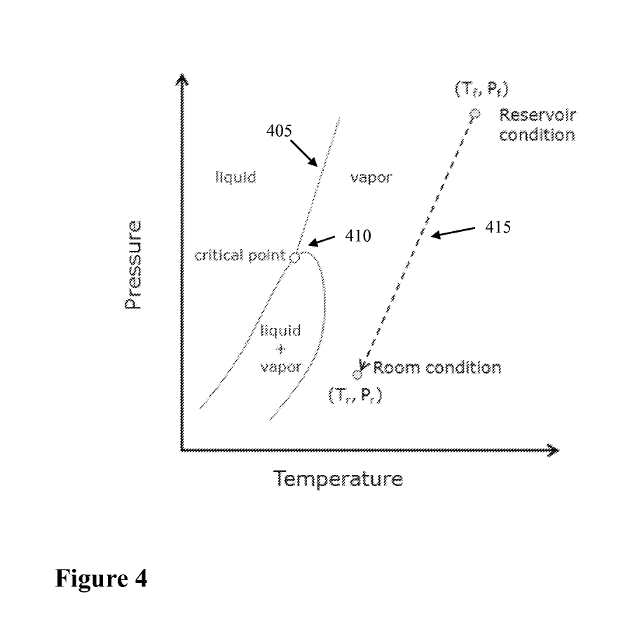

At 320, internal pressure of natural gas inclusions at reservoir temperatures can be determined using a pressure-volume-temperature (PVT) model. FIG. 4 is an example schematic pressure (P)—temperature (T) phase diagram in accordance with aspects of the present disclosure. The phase diagram shows phase boundaries between liquid and vapor 405, critical point 410 at which liquid cannot be differentiated from vapor, i.e., density of the liquid and the vapor become equal and is the point where the phase boundary between liquid and vapor single phase intersects with the (liquid+vapor) two-phase field and an isochore 415, shown as a dotted line, showing pressure and temperature change of natural gas from reservoir condition (T_{f}, P_{f}) to room condition (Tᵣ, Pᵣ). Isochore 415 is a line or contour in PT space representing the same or constant volume. The slope of the pressure change from reservoir condition to room condition is a function of gas composition. When composition of a gas inclusion is known, room temperature can be measured directly, gas pressure at room temperature can be determined as described in 315, current reservoir temperature can be estimated using regional geothermal gradient or measured directly from borehole. Paleo-temperatures may be established using a suite of thermal maturity indicators. With the temperature and pressure at room condition, Tᵣ, Pᵣ, respectively and the temperature of the reservoir known, T_{f}, the only unknown then is the gas pressure at reservoir temperature, P_{f}, which can be calculated using equation-of-state based PVT model with the above known. The equation-of-state and the PVT model can vary depending on the assumptions made about the composition of the sub-surface formations and the process in which the inclusions were formed, for example. For example, the ideal gas law can be used so long as certain assumptions are appropriate including whether a constant volume model is accurate. Other equations of state may be used such as the Peng-Robinson equation of state as would be apparent. This process can be reiterated for any other temperatures that the reservoir rock has gone through, resulting in a pressure history of the reservoir rock from the formation to present day.

Returning to the methane-ethane example above, a methane symmetric stretching Raman shift can be measured in a natural methane-ethane fluid inclusion. The measured Raman shift can then be substituted into the mathematical equation derived in 310 and 315 to solve for corresponding pressure. Noticeably, this pressure is a fluid pressure at room temperature. It normally will be significantly lower than the fluid pressure in reservoir, because most reservoir temperatures are higher than room temperature. Therefore, this pressure only places a minimum constraint for the reservoir pressure. In order to determine the fluid pressure at current or paleo reservoir conditions, the reservoir temperature is used and then the reservoir pressure can be calculated using an equation of state.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. As a further example, it is to be understood that the present invention contemplates that, to the extent possible, one or more features of any embodiment can be combined with one or more features of any other embodiment.

What is claimed is:

1. A computer-implemented method performed by one or more processors and configured to determine a pressure of a sample multi-component gas inclusion in a sub-surface formation, the computer-implemented method comprising:
determining a first set of Raman signatures for a calibration multi-component synthetic gas mixture at a plurality of temperatures, at a plurality of pressures and at a plurality of gas concentration mixing ratios to produce a model of pressure and Raman signatures;
determining a second Raman signature of the sample multi-component gas mixture in the inclusion from the sub-surface formation; and
determining a pressure of the sample multi-component gas mixture based on the determined second Raman signature and the model of pressure and the first set of Raman signatures.

2. The method according to claim 1, wherein the calibration multi-component synthetic gas mixture, the sample multi-component gas mixture, or both include methane and one or more of additional gas species.

3. The method according to claim 2, wherein the additional gas species are selected from the group consisting of: ethane, propane, butane, carbon dioxide, hydrogen sulfide and combinations thereof.

4. The method according to claim 1, wherein the determining the first set includes establishing a calibration data set for determination of relationships among Raman signal, gas pressure and gas compositions at a plurality of temperatures and at a plurality of pressures.

5. The method according to claim 1, further comprising establishing a pressure-volume-temperature (PVT) model for the second multi-component gas mixture.

6. The method according to claim 1, wherein the Raman signatures are selected from the group consisting of: a peak position, a peak area, a peak height, a peak width at half height and combinations thereof.

7. The method according to claim 6, wherein the peak position is selected from the group consisting of: a Raman methane symmetric stretching band (ν₁), a methane asymmetric stretching band (ν₃), an overtone of methane asymmetric bending (2ν₂), an ethane symmetric stretching band (ν₁), a propane symmetric stretching band (ν₁), and combinations thereof.

8. The method according to claim 1, wherein the composition of the second multi-component gas mixture in the inclusion is determined at or about room temperature.

9. The method according to claim 5, further comprising determining an internal pressure of the second multi-component gas mixture in the inclusion at reservoir temperature based on the PVT model and a pressure of the second multi-component gas mixture at or about room temperature.

10. The method according to claim 9, further comprising determining a pressure history of the inclusion based on a temperature history of the reservoir, the pressure and the temperature at or about room temperature and the PVT model.

11. A computer-implemented method including one or more processors arranged to determine a pressure of a multi-component gas inclusion in a sub-surface formation, the computer-implemented method comprising:
determining a composition of a multi-component gas mixture in an inclusion from a sub-surface formation; and
determining an internal pressure of the multi-component gas mixture based on an established gas pressure-gas Raman signature relationship for a multi-component synthetic gas mixture.

12. The method according to claim 11, wherein the multi-component gas mixture, the multi-component synthetic gas mixture, or both includes methane and one or more of additional gases.

13. The method according to claim 13, wherein the additional gases are selected from the group consisting of: ethane, propane, butane, carbon dioxide, hydrogen sulfide and combinations thereof.

14. An article of manufacture for determining pressure of a multi-component gas inclusion in a sub-surface formation comprising:
a computer usable medium having a computer readable program code embodied therein, said computer readable program code adapted to be executed by a processor to implement functions comprising:
determining a composition of a multi-component gas mixture in an inclusion from a sub-surface formation; and
determining an internal pressure of the multi-component gas mixture based on an established gas pressure-gas Raman signature relationship for a multi-component synthetic gas mixture.

15. The article according to claim 14, wherein the multi-component gas mixture, the multi-component synthetic gas mixture, or both includes methane and one or more of additional gases.

16. The article according to claim 15, wherein the additional gases are selected from the group consisting of: ethane, propane, butane, carbon dioxide, hydrogen sulfide and combinations thereof.

17. A computer-implemented method operable by one or more processors arranged to determine a pressure of a multi-component gas inclusion in a sub-surface formation, the method comprising:
acquiring Raman data for a first multi-component synthetic gas mixture;
establishing a pressure-gas Raman signal relationship for the first multi-component synthetic gas mixture;
determining a composition of a second multi-component gas mixture in an inclusion from a sub-surface formation; and
determining an internal pressure of the second multi-component gas mixture based on the established gas pressure-gas Raman signal relationship for the first multi-component synthetic gas mixture.

18. The method according to claim 17, wherein the multi-component gas mixture, the multi-component synthetic gas mixture, or both includes methane and one or more of additional gases.

19. The method according to claim 18, wherein the additional gases are selected from the group consisting of: ethane, propane, butane, carbon dioxide, hydrogen sulfide and combinations thereof.
